(19) United States
(12) Patent Application Publication
(10) Pub. No.: US 2002/0056825 A1
(43) Pub. Date: May 16, 2002

(54) Differential pressure dynamic sealing valve

(76) Inventors: Thomas A. Hartman, St. Louis, MO (US); Brian T. Hartman, Mesa, AZ (US)

Correspondence Address: THOMPSON COBURN, LLP, ONE FIRSTAR PLAZA, SUITE 3500, ST LOUIS, MO, 63101, US

(21) Appl. No.: 10/039,629

(22) Filed: Jan. 3, 2002

Related U.S. Application Data
(63) Continuation of application No. 09/553,193, filed on Apr. 20, 2000.

(51) Int. Cl. F16K 1/22; F16K 5/00

(52) U.S. Cl. 251/315.01; 251/306

(57) ABSTRACT

An annular valve seal is configured for use in a valve housing containing a rotatable-type valve that moves between open and closed positions and an internal annular groove that receives the seal. The seal comprises a resilient ring having an annular inner portion with an annular interior surface and an annular outer portion with a pair of lobes. The pair of lobes diverge axially away from each other as they project radially outwardly from the inner portion of the ring. The ring has a cross-sectional area that leaves voids between the internal annular groove and axially opposite end surfaces of the ring when the ring is inserted into the internal annular groove and the valve is in the open position.

### BACKGROUND OF THE INVENTION

1. Field of the Invention

The present invention is directed to valve seals, more specifically to resilient seals for rotatable-type valves.

2. Description of the Related Art

Rotatable-type valves are well known and are found in large variety. Such valves are commonly used in fluid piping to control the flow of fluid through the piping by opening and closing the valves. The specific construction of such valves differs widely depending on the application in which they are used. Generally, however, a valve of this type includes a valve housing having axially opposite inlet and outlet ports and a hollow interior defining a flow path between the inlet and outlet ports. The inlet port and outlet port typically have a common center axis. The rotatable valve element is mounted within the interior of the valve housing for movement between an open position wherein the valve element permits fluid flow through the valve housing, and a closed position wherein the valve element blocks the flow of fluid through the valve housing.

For example, in a butterfly valve a rotatable disk is pivotally disposed within the hollow interior of the valve housing. The valve is rotatable about an axis generally perpendicular to the flow path between a fully open position in which it is generally parallel to the flow path, and a fully closed position in which it is generally perpendicular to the flow path. In the case of a spherical plug valve (also sometimes referred to as a “ball valve”), a rotatable plug or “ball” is pivotally disposed within the hollow interior of the valve housing and is rotatable between open and closed positions. In either case, the rotatable valve element is mounted to a shaft, which is itself rotatably mounted to the valve housing. As is well known in the art, the shaft may be connected to a mechanical drive mechanism, such as an actuator, or operated manually to rotate the shaft and thereby rotate the valve element within the valve body between the open and closed positions.

The valve body has an interior surface between the inlet and outlet ports that define the flow path between the ports. An internal annular groove is formed in the interior surface with a cross section configuration adapted to receive and retain a valve seal. The internal annular groove is located so that at least a portion of the seal retained therein lies in a plane perpendicular to the flow path and where the seal will engage with the valve element in a leak-tight engagement when the valve element is rotated to its closed position. The seal may be retained in the annular groove by many means, including adhesives, frictional engagement, welding, and by fasteners.

Various types of seals have been proposed and used to seal rotatable-type disk valves. For example, some seal types utilize a two piece construction while others utilize a single piece construction for the seal. Typically, these seals, such as those disclosed in U.S. Pat. Nos. 3,544,066 and 3,799,501, utilize a one piece seal and a curable polymeric material, such as an epoxy resin, to retain the valve seal within the internal annular groove of the valve body. Typically, the axial dimension of the internal annular groove is smaller than the axial dimension of the valve seal to provide a tight friction fit between the valve seal and the annular groove. Therefore, the valve seal is first forcibly inserted into the internal annular groove. Once the seal has been forcibly placed in the annular groove, an epoxy resin or other polymeric material is introduced, in liquid form, between an annular exterior surface of the seal and the internal annular groove. Finally, the resin is allowed to cure, thereby retaining the valve seal within the internal annular groove of the valve body.

Because the annular inner portion of the seal is axially dimensioned to fit snug within the walls of the internal annular groove at the annular groove opening, there is no allowance for any axial expansion of the seal at the annular inner portion. Therefore, when the valve element is rotated to its closed position, it compresses the seal radially outwardly which is resisted by the resiliency of the seal and the resiliency of the polymeric material inserted between the seal and the internal annular groove. Because the polymeric material, once it has set up, is generally not compressible, the seal must absorb all of the radially outward compressive force being exerted by the valve element. Therefore, it is critical that the seal be correctly radially dimensioned in order for the seal to exert a sufficient counter compressive force radially inwardly against the valve element and the fluid pressure so that a leak-tight engagement with the valve element is achieved along the entire circumference of the seal. To this end, the prior art valves have typically used seals with a durometer reading or hardness that is greater then that required in order to compensate for incorrect radial dimensioning of the seal. These harder seals are more difficult to insert into the annular groove due to the difficulty in compressing and inserting the annular outer portions of the seal into the much narrower annular groove opening.

Another problem of the prior art valve seals is that as the valve seal wears, the radially outward compression of the seal caused by moving the valve element to its closed position decreases. As the radially outward compression caused by the valve element decreases, the corresponding opposing radially inward force caused by the resiliency of the seal decreases proportionally, thereby reducing the effective pressure rating/capacity of the valve. The prior art valve seals do not have a mechanism that allows for self compensation of the decreasing radially outward compression of the seal to retain a leak-tight engagement with the valve element.

In valves used in high liquid pressure environments it is necessary that the valve element and the seal of the valve housing engage in sound liquid tight engagement when the valve element is moved to its closed position. To achieve the sound liquid tight engagement between the valve element and the seal, the seal is typically constructed with an annular inner portion that projects radially inwardly from the valve groove of the valve housing into the interior of the valve housing where the annular inner portion of the seal will be compressed by the valve element when the valve element is moved to its closed position. In the design of prior art valve seals it was considered that the more the valve seal annular inner portion is compressed by the valve being moved to its closed position, the better the liquid tight seal between the valve seal and the valve element. To obtain increased compression of the valve seal annular inner portion by the valve element moved to its closed position, valve seals were designed so that their annular inner portion projected radially inwardly to an increased extent in order to increase the compression of the annular inner portion when the valve element was moved to its closed position. However, it has been observed that the additional interference between the valve seal and valve element created by extending the annular inner portion of the valve seal radially into the interior bore of the valve housing resulted in over-compression of the valve seal. Through repeated opening and closing cycles of the valve element, the over-compression of the valve seal each time the valve element is moved to its closed position would eventually damage the material of the seal and reduce its ability to provide a liquid tight seal with the valve element.

What is needed to overcome the disadvantages experienced in prior art valve seals in high liquid pressure environments is a valve seal that exerts an increased compressive force against the valve element when the valve element is moved to its closed position without significantly increasing the extent to which the annular inner portion of the valve seal projects radially inwardly into the bore of the valve housing.

### SUMMARY OF THE INVENTION

The present invention overcomes the shortcomings of the prior art valve seals by providing a valve seal which has an annular inner portion that has a thickness or an axial dimension that is slightly smaller than the width or axial dimension of the annular groove opening of the valve housing. The smaller axial dimension of the annular inner portion of the valve seal spaces axially opposite end surfaces of the annular inner portion of the seal from the axially opposite side walls of the annular groove. The annular outer portion of the seal is axially dimensioned to engage the axially opposite side walls of the annular groove to thereby retain the valve seal in the annular groove in conjunction with an epoxy resin.

The present invention also overcomes the shortcomings of prior art valve seals by providing a valve seal whose radial dimension is not as critical to effectuating a liquid-tight engagement with the valve element as is required by the prior art valve seals. Furthermore, the valve seal of the present invention is self compensating for the wear of the valve seal due to long term usage and thereby increases the useful life of a valve containing the valve seal of the present invention.

In general, a seal of the present invention is configured for use in valve housings having an internal annular groove adapted to receive the seal therein and a rotatable valve element that is movable between open and closed positions in the valve housing. The seal comprises a resilient ring dimensioned to fit inside the internal annular groove. The ring has an annular inner portion with an annular inner surface having a center axis, and an annular outer potion with a pair of lobes that diverge axially away from each other as they project radially outwardly from the inner portion of the ring. The ring inner portion has a thickness or an axial dimension that leaves voids between the opposing side walls of an inner section of the internal annular groove and axially opposite end surfaces of the ring when the ring is inserted into the internal annular groove.

In another aspect of the invention, the seal comprises a valve housing having an internal annular groove and a resilient ring fit inside the internal annular groove. The valve housing also contains a rotatable valve element that is movable between opened and closed positions of the valve in the valve housing. The resilient ring has an annular outer portion that has an axial width that causes the outer portion to engage with opposed side walls of the internal annular groove. The resilient ring also has an annular inner portion that has an axial width that causes the inner portion to be spaced from the opposed side walls of the internal annular groove with voids between the opposed side walls and the inner portion of the ring.

### BRIEF DESCRIPTION OF THE DRAWINGS

Further objectives and features of the present invention are set forth in the following detailed description of the preferred embodiment of the invention and in the drawing figures wherein:

FIG. 1 is in elevation view of a rotational-type valve assembly of the present invention in the closed position;

FIG. 2 is a top plan view of the valve assembly of FIG. 1;

FIG. 3 is a cross-sectional view of the valve assembly taken along the plane of line 3-3 in FIG. 2, with the valve assembly in the closed position;

FIG. 4 is a cross-sectional view of the valve seal of the present invention;

FIG. 5 is a partial, cross-sectional view of the valve seal of the present invention seated within the valve housing annular groove; and

FIG. 6 is a partial, cross-sectional view of the valve seal of the present invention seated within the valve housing annular groove with the valve element in the closed position.

Reference characters in the written specification indicate corresponding parts throughout the several views of the drawings.

### DETAILED DESCRIPTION OF THE PREFERRED EMBODIMENT

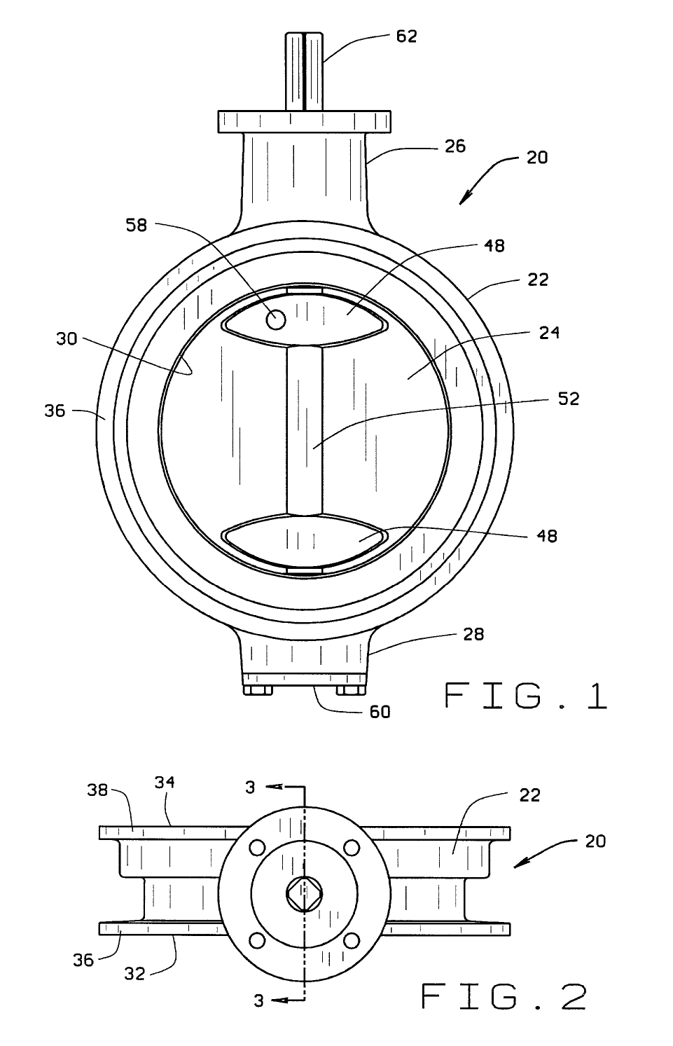

FIGS. 1 and 2 show a conventional disk valve in a valve housing, which is one operative environment in which the present invention may be employed. However, the environment of the invention shown in FIGS. 1 and 2 is only one example as to how the valve seal of the invention may be employed, and it should not be interpreted as the only environment in which the valve seal may be employed. For example, the valve seal of the present invention may also be employed in a spherical plug valve (or “ball valve”) assembly or any other valve assembly having a moveable valve element that is brought into and out of sealing engagement with a resilient annular valve seal. Therefore, the operative environment disclosed hereinafter should not be interpreted as limiting the scope of the invention.

The rotatable disk valve assembly 20 shown in the drawing figures includes a valve housing 22 and a disk valve element 24 mounted in the housing for pivoting movement of the disk valve between opened and closed positions of the valve. Because the disk valve assembly 20 is only one environment in which the valve seal of the invention may be employed, and because its construction is for the most part conventional, it will only be described generally herein.

The valve housing 22 is generally cylindrical except for an upper shaft hub 26 and a lower shaft hub 28 that project from radially opposite ends of the housing exterior surface. A generally cylindrical interior bore surface 30 passes through the valve housing 22 from an upstream end 32 to a downstream end 34 of the housing. As viewed in FIG. 3, the upstream end 32 of the interior bore is at the left side of the housing and the downstream end 34 of the interior bore is at the right side of the housing, although the direction of the flow of liquid through the valve housing 22 is not critical to the operation of the present invention, and could be reversed. The housing exterior surface is provided with a circular upstream flange 36 and a circular downstream flange 38. The flanges are employed in connecting the valve housing 22 between adjacent upstream and downstream lengths of pipe (not shown). As is conventional, the housing can be connected between the two lengths of pipe by threaded fasteners inserted through aligned holes in the flanges 36, 38 of the valve housing and mating flanges of the upstream and downstream lengths of pipe. Alternatively, and depending on the size of the particular valve assembly 20 with which the invention is used, connections between the valve housing 22 and adjacent lengths of pipe can be accomplished with complementary threaded connectors and other known means of connecting pipe to valve housings.

As shown in FIG. 3, an upper section of a shaft hole 40 passes through the upper shaft hub 26 and a lower section of a shaft hole 42 passes through the lower shaft hub 28. Positioned just downstream from the shaft holes 40, 42 is an internal annular groove 44 formed in the interior bore surface 30 and extending completely around the interior bore surface. The particular configuration of the groove 44 and its relation to the seal of the invention are novel features of the groove that will be explained later.

The disk valve element 24 has a circular configuration with a generally cylindrical or frustoconical sealing surface 46 extending around its periphery. A pair of ridges 48 extend across an upstream face of the valve element 24. Aligned shaft holes 50 extend through the ridges. A shaft 52 passes through the upper section of the shaft hole 40 in the upper shaft hub 26, through the pair of shaft holes 50 in the valve element ridges 48, and into the lower section of the shaft hole 42 in the lower shaft hub 28 of the valve housing 22. The lower end of the shaft 52 is received for rotation in a pivot bushing and seal assembly 54 represented at the bottom of the lower section of the shaft hole 42. The opposite end of the shaft 52 is received in a pivot bushing and seal assembly 56 represented at the top of the upper section of the shaft hole 40. Referring to FIG. 1, a key pin 58 passes through a hole in the upper disk valve ridge 48 and into a notch (not shown) in the shaft 52 securing the disk valve element 24 and the shaft 52 together. A circular flange 60 is secured to the lower shaft hub 28 over the lower bushing and seal assembly 54. A stub portion 62 at the opposite end of the shaft 52 projects from the upper shaft hub 26 of the valve housing. An actuator of any known type, either manually operated or mechanically operated, is connected to the stub portion 62 of the shaft 52 and is operated to rotate the shaft 52 and the attached valve element 24 between their opened and closed positions.

A closed position of the valve element 24 relative to the valve housing 22 is shown in FIGS. 1, 3 and 6. In this position, the valve element 24 is positioned generally perpendicular to the center axis of fluid flow 64 through the interior bore 30 of the valve housing. To completely open the valve element 24, the shaft 52 and the attached valve element 24 are rotated 90° to position the disk valve element 24 generally parallel to the center axis of fluid flow 64 through the interior bore 30 of the valve housing.

FIG. 3 shows a cross-section of the internal annular groove 44 in the interior bore surface 30 of the valve housing 22, and FIGS. 5 and 6 show the annular groove 44 in more detail. Referring to FIG. 5, the internal annular groove 44 is formed with a groove inner section 66 which is comprised of axially opposite groove inner side walls 68, 70, a groove outer section 72 which is comprised of axially opposite groove outer side walls 74, and a groove bottom wall 76, all of which extend completely around the cylindrical interior bore surface 30 of the valve housing 22. Together, the groove bottom wall 76, the groove inner side walls 68, 70, and the groove outer side walls 74 surround and define an annular channel 78 of the internal annular groove 44. As shown in FIG. 5, the cross-section of the groove inner section 66 is generally rectangular and the cross-section of the groove outer section 72 is generally trapezoidal, with the groove outer side walls 74 extending axially away from each other as they extend radially away from the groove inner side walls 68, 70 and towards the groove bottom wall 76. This facilitates retention of an annular valve seal 80 within the internal annular groove 44, as will be explained.

The construction of the disk valve assembly 20 to this point is, except for the configuration of the internal annular groove 44, conventional and many of the described component parts, and the features of their construction, can be found in various types of known valve assemblies. However, as will be explained, the configuration of the internal annular groove 44 and its relationship to the construction of the annular valve seal 80 is an improvement over prior art valves seals.

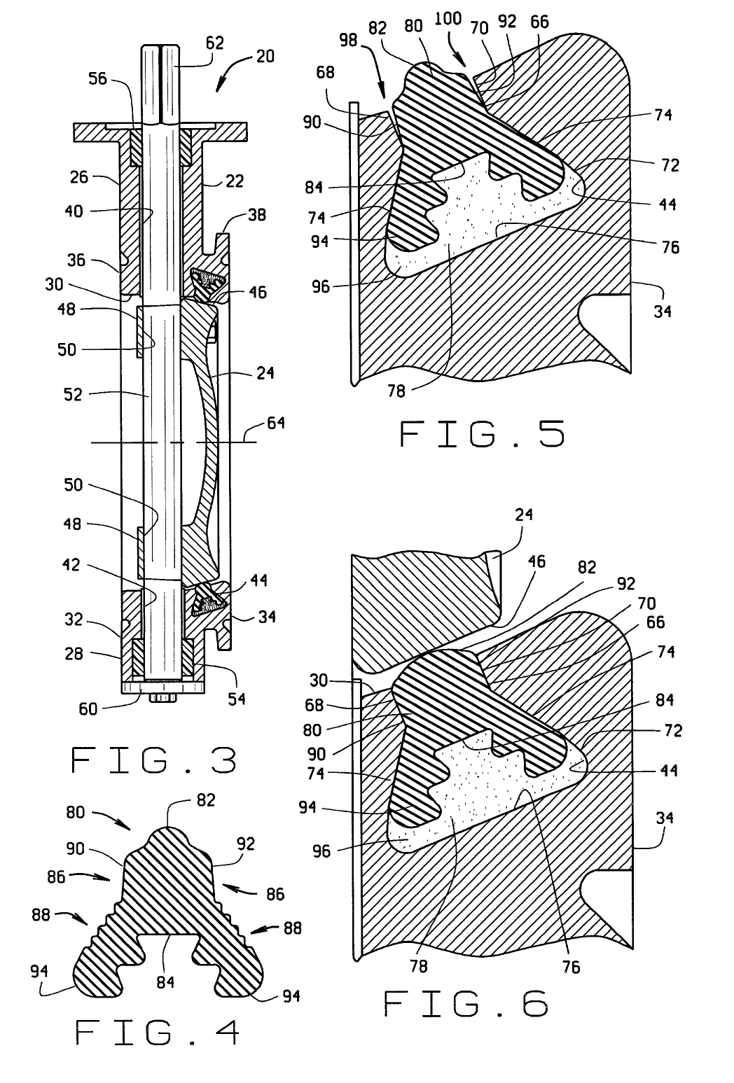

The valve seal 80 of the invention is preferably constructed of a resilient, compressible material of the type typically used in valve seals, e.g., rubber. As shown in FIG. 4, the valve seal 80 includes an annular interior surface 82, an annular exterior surface 84 generally opposite the annular interior surface 82, an annular inner portion 86, and an annular outer portion 88. The annular interior surface 82 defines a central opening of the valve seal 80. A portion of the annular interior surface 82 defines a seating surface which is adapted for engagement with the disk valve element 24 to prevent fluid flow through the central opening of the valve seal 80 when the disk valve element is in the closed position. The valve seal inner portion 86 has a width or axial dimension between a first, upstream end surface 90 of the inner portion and an opposite second, downstream end surface 92 of the inner portion.

The annular upstream 90 and downstream 92 end surfaces of the annular inner portion 86 of the valve seal 80 taper axially toward one another as the valve seal 80 extends radially inwardly from the annular outer portion 88. The tapering of the end surfaces 90, 92 as they extend to the annular interior surface 82 gives the annular inner portion 86 of the seal an axial dimension that is less than the axial dimension of the groove inner section 66.

The annular outer portion 88 of the seal is comprised of a pair of lobes 94 that diverge axially away from each other as they project radially outwardly from the annular inner portion 86, thereby giving the annular valve seal 80 a generally Y-shaped cross-sectional configuration. When the valve seal 80 is inserted into the internal annular groove 44, the lobes 94 of the annular outer portion 88 engage with the outer side walls 74 of the groove outer section 72, which facilitates retention of the valve seal 80 within the annular groove 44.

Preferably, a body of polymeric material 96 is introduced into the annular channel 78 between the annular exterior surface 84 of the valve seal 80 and the groove bottom wall 76. As explained below, the polymeric body 96 engages with the internal annular groove 44 and the annular exterior surface 84 of the valve seal 80 in a manner to retain the annular valve seal 80 within the annular groove 44. The polymeric body is preferably of a curable polymeric material, such as an epoxy resin, that has cured to a solid condition. The general concept of using a curable epoxy resin to retain a valve seal within an annular groove of a valve body is disclosed in U.S. Pat. Nos. 3,544,066 and 3,799,501. Similarly, in the present invention, the valve seal 80 is first inserted into the internal annular groove 44. Then, the epoxy resin or other polymeric material is introduced in a liquid form, via an inlet port (not shown), into the annular channel 78 between the annular exterior surface 84 of the seal 80 and the groove bottom wall 76. Introduction of the polymeric material into the annular channel 78 forces the annular valve seal 80 radially inwardly until the annular outer portion 88 and the lobes 90 engage and compress against the side walls 74 of the groove outer section. Finally, the resin is allowed to cure to a solid condition, thereby retaining the valve seal 80 within the annular groove 44.

As can be seen in FIG. 5, when the valve seal 80 is retained within the annular groove 44, the annular inner surface 82 projects radially inwardly toward the center axis of flow 64 beyond the cylindrical interior bore surface 30 of the valve housing. The annular inner portion 86 of the valve seal 80 is axially dimensioned to be spaced axially from the side walls 68, 70 of the groove inner section 66, thereby creating respective upstream and downstream voids 98, 100 between the annular inner portion 86 of the annular seal 80 and the groove inner section 66.

In operation, the disk valve element 24 is rotated via shaft 52 from a fully opened position, wherein the disk valve element 24 is generally parallel to the center axis of flow 64, to a fully closed position wherein the disk valve element 24 is generally perpendicular to the center axis of flow 64. When the disk valve element 24 is in its fully closed position, the sealing surface 46 of the valve element engages the annular inner surface 82 of the seal 80, thereby compressing the seal 80 radially outwardly. The radial outward compression of the valve seal 80 compresses the annular inner portion 86 of the seal into the annular groove 44, causing an axial expansion of the annular inner portion 86 which closes the upstream and downstream voids 98, 100.

The resilience of the material of the valve seal 80 resists the radially outward compression force of the valve element 24. The resistance to the radially outward compression force exhibited by the valve seal 80 is determined by its hardness/resiliency and the amount of axial expansion available due to the voids 98, 100. The compression of the valve seal 80 and its resistance to this compression causes the sealing surface 46 of the disk valve element 24 to sealingly engage in a liquid-tight engagement with the annular inner surface 82 of the annular valve seal 80.

Because the valve seal 80 of the present invention is axially dimensioned so that there are upstream and downstream voids 98, 100, the radial dimension of the valve seal 80 is not as critical to effectuating a leak-tight seal as that of the prior art valve seals. In the event that the radial dimension of the valve seal 80 is larger than required, the upstream and downstream voids 98, 100 allow for axial expansion of the valve seal 80 due to the radially outwardly compression caused by the closing of the disk valve element 24, and therefore the valve seal 80 does not exert as large a counter compressive force as if there were no void 98, 100. Additionally, because the present invention allows for axial expansion of the valve seal 80 due to the upstream and downstream voids 98, 100, the radial dimension of the valve seal 80 can be larger than in the prior art seals, thereby ensuring adequate engagement with the valve element sealing surface 46 and allowing for more imperfections in the valve element sealing surface 46 without detracting from the sealing capacity of the disk valve assembly 20.

In the event that the radial dimension of the valve seal 80 is such that when the disk valve element 24 is in its fully closed position the upstream and downstream voids 98, 100 still exist, the fluid contained in the valve assembly will be in communication with the upstream void 98. The fluid communicating with the upstream void 98 exerts a compressive force generally perpendicular to the surface of the valve seal 80 with which the fluid is in contact. Fluid in the upstream void 98 will exert a generally axial compressive force on the valve seal 80. The axial compressive force exerted by the fluid in the upstream void 98 causes axial expansion of the valve seal radially inwardly. This radially inward expansion caused by the fluid pressure in the void 98 further helps to sealingly engage the annular inner surface 82 of the valve seal 80 and the sealing surface 46 of the disk valve element 24 in a liquid-tight engagement. Because the fluid pressure causes an axial compression of the valve seal which is partially translated into radially inwardly expansion of the valve seal 80, the radial dimension of the valve seal 80 to meet the design capacity of the valve is not as critical as that of the prior art valve seals. Because the radial dimension is less critical, a softer material may be utilized for the valve seal 80. The ability to utilize a softer material for the valve seal 80 facilitates the placement of the valve seal 80 into the annular groove 44. Because the outer portion 88 of the valve seal 80 is axially dimensioned larger than the grooved inner section 66, the outer portion 88 of the valve seal 80 must be physically compressed or squeezed to fit into the annular groove 44. Because a softer material can be utilized for the valve seal 80, the compressive force or squeezing force required to fit the outer portion 88 into the annular groove 44 is less and the difficulty of the insertion is reduced over that required in the prior art valve seals.

In the preferred embodiment, the upstream and downstream voids 98, 100 are completely filled due to the axial expansion of the inner portion 86 of the valve seal 80 when the valve is in the closed position. However, as the interior surface 82 and the sealing surface 46 wear from extended and repeated use, the compressive force caused by the disk element 24 will be reduced over time and the resulting axial expansion of the inner portion 86 of the valve seal 80 may no longer encompass the entire upstream and downstream voids 98, 100. When the voids 98, 100 are not filled with the valve seal 80, as was discussed above, the fluid in the valve housing 22 will be in communication with the upstream void 98 and the inner portion 86 of the valve seal 80. The fluid pressure within the upstream void 98 will exert an axial compressive force on the inner portion 86 of the seal resulting in a radially inward expansion of the valve seal 80, thereby increasing the sealing force between the sealing surface 46 and the interior surface 82. This increase in the sealing force is the valve self compensating for the wear of the valve seal 80 over time. Because the prior art valve seals do not have any voids between their seals and their annular grooves, they are not self compensating and when the compressive force exhibited by the disk valve element on the seal is sufficiently diminished, their capacity drops and their useful life span is reduced.

While the present invention has been shown with an upstream void 98 and a downstream void 100 it is to be understood that a similar valve seal 80 can be designed that utilizes only an upstream void 98, or a downstream void 100. Additionally, because the preferred embodiment of the present invention utilizes both an upstream void 98 and a downstream void 100, the valve does not have a preferred upstream and downstream orientation and can function equally as well in a reverse mode of fluid flow.

While the present invention has been described by reference to specific embodiments, it should be understood that modifications and variations of the invention may be constructed without departing from the scope of the invention as defined by the following claims.

What is claimed:

1. A seal for a valve housing containing a rotatable valve that is movable between open and closed positions in the valve housing and having an internal annular groove adapted to receive the seal, the seal comprising:
a resilient ring dimensioned to fit inside the internal annular groove when the ring is inserted into the internal annular groove, the resilient ring has an annular inner portion with an annular interior surface having a center axis, an annular outer portion with a pair of lobes that diverge axially away from each other as they project radially outwardly from the inner portion of the ring, and axially opposite first and second circular end surfaces that extend radially between the inner portion and outer portion of the ring, and the ring has a cross-sectional area that leaves voids between the internal annular groove and the first and second end surfaces of the ring when the ring is inserted into the internal annular groove.

2. The seal of claim 1, wherein:
the ring has a Y-shaped cross-sectional configuration.

3. The seal of claim 1, wherein:
the ring inner portion is compressible and will expand axially outwardly when the annular interior surface is compressed radially outwardly.

4. The seal of claim 1, wherein:
the ring inner portion has a circumferential dimension that positions the interior surface of the ring radially inwardly from the internal annular groove when the ring is inserted into the groove.

5. The seal of claim 1, wherein:
the outer portion of the ring has an axial width that causes the outer portion to engage with axially opposite side walls of the internal groove when the ring is inserted into the groove and the inner portion of the ring has an axial width dimension that causes the inner portion to be spaced axially from the opposite side walls of the internal groove when the ring is inserted into the groove and the valve is in the open position.

6. The seal of claim 5, wherein:
the inner portion of the ring is compressible whereby it will compress radially and expand axially when the ring is inserted into the internal groove and the valve is in the closed position.

7. The seal of claim 1, for the valve housing having the internal annular groove, the groove having an inner section that has axially spaced side walls that extend radially into the valve housing from an opening of the groove and an outer section that has axially spaced side walls that diverge from each other and from the inner section side walls as they extend from the inner section side walls to a bottom wall of the groove, the seal further comprising:
the pair of lobes of the annular outer portion of the ring diverge axially away from the annular inner portion of the ring and from each other to where they will engage with the side walls of the center section of the internal groove when the ring is inserted in the groove.

8. A seal comprising:
a valve housing containing a rotatable valve that is moveable between opened and closed positions of the valve in the valve housing and having an internal annular groove; and
a resilient ring fit inside the internal annular groove, the resilient ring has an annular outer portion that has an axial width that causes the outer portion to engage with opposed side walls of the internal annular groove and the resilient ring has an annular inner portion that has an axial width that causes the inner portion to be spaced from the opposed side walls of the internal annular groove with voids between the opposed side walls and the inner portion of the ring.

9. The seal of claim 8, wherein:
the internal annular groove has a groove opening in the valve housing to an inner section of the groove that has axially spaced side walls that extend radially into the valve housing from the groove opening and an outer section of the groove that has axially spaced side walls that diverge axially from each other and from the inner section side walls as they extend radially from the inner section side walls toward a bottom wall of the groove.

10. The seal of claim 9, wherein:
an adhesive is positioned in the groove between the bottom wall of the groove and the outer portion of the ring.

11. The seal of claim 9, wherein:
the annular outer portion of the ring includes a pair of lobes that extend axially away from the annular inner portion of the ring as they extend radially away from the annular inner portion of the ring.

12. The seal of claim 11, wherein:
the pair of lobes are fit in the outer section of the internal annular groove and the inner portion of the ring is received in the inner section of the groove.

13. The seal of claim 12, wherein:
the inner portion of the ring projects radially inwardly from the groove opening.

14. The seal of claim 8, wherein:
the internal annular groove positions the ring in the valve housing where the valve will engage with the ring inner portion when the valve is in the closed position and the ring inner portion is compressible whereby the ring inner portion will compress radially and expand axially when the valve is in the closed position.

15. The seal of claim 14, wherein:
the ring inner portion is compressible whereby the ring inner portion will compress radially and expand axially occupying the void between the opposed side walls of the internal annular groove and the inner portion of the ring when the valve is in the closed position.

16. The seal of claim 8, wherein:
the valve housing has a hollow interior bore that contains the rotatable valve and communicates with the voids between the opposed side walls of the internal annular groove and the inner portion of the ring.

17. The seal of claim 16, wherein:
the hollow interior bore communicates with the voids when the valve is in the opened position.

18. The seal of claim 17, wherein:
the hollow interior bore does not communicate with the voids when the valve seal is in the closed position.

19. The seal of claim 8, wherein:
the ring has a Y-shaped cross-sectional configuration.
